(19) United States
(12) Patent Application Publication
(10) Pub. No.: US 2014/0086008 A1
(43) Pub. Date: Mar. 27, 2014

(54) INVERSE TIMING METHOD, APPARATUS, AND APPLICATIONS

(71) Applicant: FAIRFIELD INDUSTRIES INCORPORATED, Sugar Land, TX (US)

(72) Inventors: Walter Pharris, Weston Lakes, TX (US); William Hopewell, Richmond, TX (US)

(73) Assignee: FAIRFIELD INDUSTRIES INCORPORATED, SUGAR LAND, TX (US)

(21) Appl. No.: 13/836,886

(22) Filed: Mar. 15, 2013

Related U.S. Application Data
(60) Provisional application No. 61/704,814, filed on Sep. 24, 2012.

(51) Int. Cl. G01V 1/38

(52) U.S. Cl. CPC G01V 1/38
USPC 367/21

(57) ABSTRACT

An ‘inverse timing’ method advantageously utilized for marine seismic applications involving one or more autonomous nodes involves the step of synchronizing the timing of newly recorded and/or prior recorded seismic data with a ‘true’ time whereby the synchronizing of timing is performed in a non-traditional ‘reverse’ manner rather than the traditional manner that is performed prior to recording the seismic survey data.

The instant application claims priority to U.S. provisional application Ser. No. 61/704,814 filed on Sep. 24, 2012, the subject matter of which is incorporated herein by reference in its entirety.

Embodiments of the invention are generally directed to timing and time synchronization methods, apparatus utilizing these methods, and applications of said methods and apparatus, and more particularly to said methods, apparatus, and applications directed to precisely and accurately creating a seismic data record, most particularly a marine seismic data record.

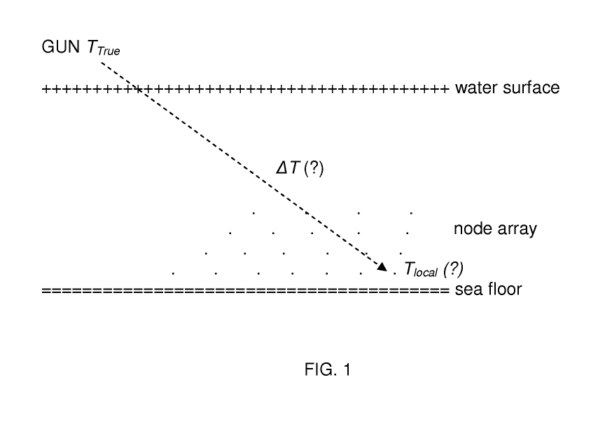

The ability to generate meaningful and commercially valuable seismic surveys critically relies on the accuracy and precision of the timing relationships between source and signal generation and recordation events. This is particularly challenging in the marine seismic environment. Referring to the illustration in FIG. 1, a node field may consist of a large array (e.g., 200 to 2000+) of autonomous nodes (e.g., ocean bottom sensors (OBS); ‘nodes’) disposed on the sea floor. It may have taken 30 days or more to place the node array. In conducting what are known as surveys (e.g., 4D surveys), the nodes are deployed. The nodes' clocks may typically be in a power conservation (sleep or OFF) mode for weeks, months, or years between surveys to conserve battery power and must be powered up when a sensing record (survey) is to be made.

To effect a marine seismic record, a surface vessel equipped with a GPS-, atomic clock-, or other precision timing device-synchronized seismic source (e.g., air gun) shoots a signal towards the ocean bottom in the vicinity of the node array at a precisely known time; however, the local (resident in) node clock (referred to hereinafter as the ‘node clock’) may not and likely will not be synchronized to any ‘true’ time (e.g., world time, called Coordinated Universal Time (UTC)) regardless of the precision of the timing device (e.g., a voltage controlled oscillator, atomic clock, others; due to, e.g., clock warm-up/stabilization, time drift, and other known factors); thus it will be difficult to accurately determine the real (true) start time and the precise recording times of a nodal seismic record. Moreover, even if a true source (signal) time is known, water temperature variations, salinity, turbidity, and other factors may uncontrollably affect the ability to know a precise relationship between source time and record time events.

Conventional practices including, but not limited to, node clock synchronization prior to node (sensor) deployment, or node clock synchronization prior to establishing the seismic record consume considerable resources and time. For example, when an atomic clock (AC) is used as a node clock, clock stabilization characteristics may not be accurately known during some warm-up duration after starting the clock. If an AC, for example, is remotely restarted, there may be an unknown offset time from true time that can adversely affect precise recording. The effects of quickly changing environmental conditions such as the change in temperature between the air and the water into which a running, pre-synchronized clock is deployed may also alter the ability to precisely and accurately obtain a seismic record.

Applicant's pending US Published Application 2009/0080290 entitled Method and Apparatus for Correcting the Timing Function in a Nodal Seismic Data Acquisition Unit provides additional pertinent background and inventive solutions in the seismic timing field. The subject matter of the '290 published application is incorporated herein by reference in its entirety to the fullest extent allowed by applicable laws and rules.

It would be highly advantageous to provide solutions to the above mentioned and related known challenges and problems associated with precisely and accurately creating a seismic record. It would be particularly advantageous to provide a solution in which node clock synchronization occurred after acquisition of the seismic data record, such that a ‘true’ time could be assigned to the timing schedule of the local node clock for the newly recorded data. Embodiments and aspects of the invention described herein set forth advantageous and beneficial novel solutions to these and related challenges and problems known in the art.

Embodiments of the invention include apparatus, and method(s) and applications utilizing the embodied apparatus and/or method(s) pertaining to the timing, acquisition, synchronization, precision, accuracy, recordation, transfer, etc. of data to, by, and/or from one or more autonomous nodal seismic data acquisition units (‘nodes’), particularly but not limited to autonomous, marine seismic (mid- and deep-water) nodes. As used herein, ‘true’ time refers to the precise real world clock time used as a standard, which may be, e.g., ‘world time’ or Coordinated Universal Time (UTC). As used herein, ‘record’ or ‘seismic record ‘refers to a recording of seismic data, which may include a plurality of sequenced data records obtained after each of a plurality of shot sets or a continuous recording of seismic data over a selected time interval. As used herein, ‘synchronization’ time will refer to that instant of time of the recording of seismic data that is to be synchronized to true time and from which point the data-record timing prior to the synchronization time can precisely be determined. The synchronization may, but need not be a final or intermittent ‘stop’ time of the record.

A non-limiting embodiment of the invention is a timing method referred to herein as ‘inverse timing.’ The method may advantageously be utilized for, e.g., marine seismic applications involving one or more autonomous nodes. The inverse timing method involves the step of synchronizing the timing of newly recorded and/or prior recorded data with a ‘true’ time whereby the synchronizing of timing is performed in a non-traditional ‘reverse’ manner rather than the traditional manner that is performed prior to recording the seismic survey data.

An illustrative inverse timing method includes the steps of establishing a running condition of a local node clock in each of one or more nodes, including generating a local timing schedule; recording seismic data with the node while the timing schedule is running to generate a seismic record; selecting a time of the seismic recording with a discrete value of the timing schedule of the running node clock to establish a synchronization time; associating a true time with the synchronization time; and assigning the true time to the discrete value of the timing schedule of the running node clock, wherein the timing schedule of the running node clock prior to the discrete value of the timing schedule can be accurately associated the true time. In various exemplary, non-limiting aspects the inverse timing method may include one or more of the following further steps or characterizations:
establishing the running condition of the node clock(s) after the node(s) is deployed on the sea floor;
wake-up/start the local node clock;
determining a stabilization characteristic, parameter, or metric for the node clock;
   wherein the stabilization characteristic, parameter, or metric enables an accurate association of the timing schedule of the running node clock during a start-up, warm-up, imprecise, close, or non-stabilized duration or portion of the timing schedule with corresponding ‘true’ times;
making the seismic survey data record with the node simultaneously with the timing schedule of the running node clock;
wherein the step of associating a ‘true’ time with the ‘synchronization’ time involves establishing at least one of an RF, electrical, inductive, and acoustic communication link with the node;
wherein the step of associating a ‘true’ time with the ‘synchronization’ time involves establishing an optical communication link with the node;
   establishing the optical communication link between the node and an ROV, an AUV, a towed vehicle, another one or more nodes, or other;
   transferring the true time to the node and associating the true time with the recording time in the node;
   transferring the discrete value of the timing schedule of the running node clock to a node-external location associated with the true time;
establishing a true source signal start time, tₜᵣᵤₑ for a given survey;
   correlating the true node time with the true source signal start time, tₜᵣᵤₑ for a given survey;
reassigning a true node time to one or more prior survey records made by a node;
wherein the node clock is an atomic clock (or any suitable similarly accurate and precise timing mechanism);
wherein the true source signal start time, tₜᵣᵤₑ is based on a GPS, GPS III, GLONASS (Russian GLObal NAvigation Satellite System), European Union Galileo positioning system, Chinese Compass navigation system, Indian Regional Navigational Satellite System, or other similar system;
wherein establishing a survey record involves creating a metacontent in the node for a dataset associated with the given survey;
establishing a time offset between a true time value and a discrete timing value of the node clock in a metacontent in the node; and
performing all method steps without physical contact with the node in the operational environment of the node.

In conjunction with the embodied inverse timing method, an embodied inverse timing system includes a true time source; a node operatively, wirelessly coupled to the true time source, wherein the node includes a local clock characterized as being in one of a non-running/sleep mode and a running mode and further characterized by a timing schedule and a time stamp in the running mode, further wherein the node includes a data recorder and a data record file operatively coupled to the timing schedule, wherein the data record file contains new recorded seismic data or does not contain new recorded seismic data; at least one of a transmitter, a receiver, and a transceiver operatively coupled to the true time source and the node, wherein the local node clock is in an unsynchronized running condition for a given time after the data record file contains new recorded seismic data prior to being in a synchronized running condition after the data record file contains new recorded seismic data.

Additional information including that in regard to nodes and synchronization between the timing of seismic sensor data acquisition and the initiation of a seismic source signal is disclosed in co-owned U.S. Pat. No. 7,310,287, the subject matter of which in herein incorporated by reference to the fullest extent allowed by applicable laws and rules.

FIG. 1 schematically illustrates an exemplary marine seismic environment.

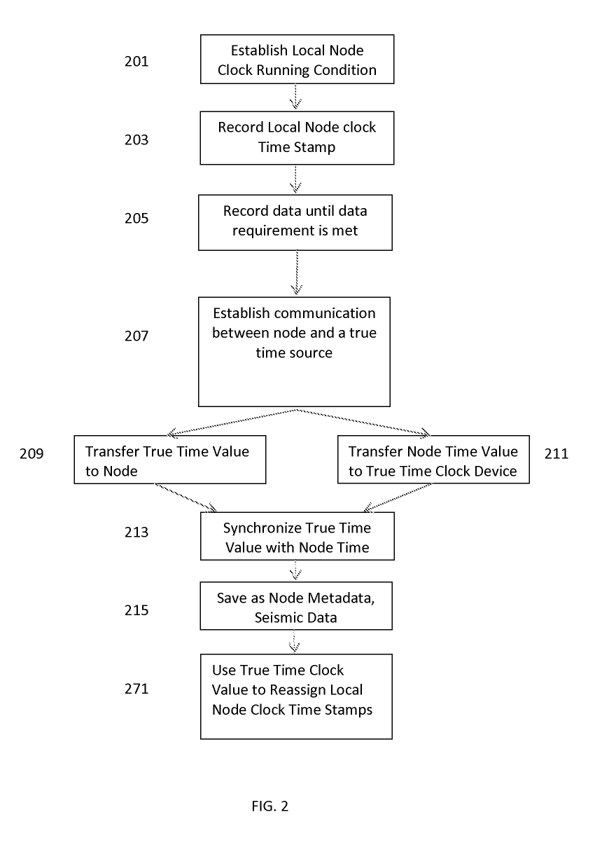

FIG. 2 is a flowchart setting forth various primary and optional additional steps of a timing method according to a non-limiting, exemplary aspect of the invention.

In all aspects of the invention, ‘true’ time is available from a true time source as is known in the art. For the purpose of understanding the invention and, in particular, the claim terminology, the following terms have the identified meanings as follow: Running condition of a local node clock means that the local clock has appropriately been ‘woken-up,’ started, and has been determined to be running in a stabilized timing state/condition. Local timing schedule means a time stamp data stream in the node. Seismic record means a record or set of records of seismic data recorded by the node. Selected time of the seismic data record means a particular point in the seismic data record to be associated with a time stamp value. Synchronization time means assigning the time stamp value to the selected time of the seismic data record. A stabilization characteristic, parameter, or metric for the node clock means a substantial assurance that the local clock is running in a time-stabilized (i.e., predictable) condition. Source signal start time means the firing time of a seismic source (gun) signal. Metacontent means data about data content; e.g., offset timing; timing data of the recorded seismic data. A new seismic data record (survey) and a prior recorded seismic data record (survey) mean time-stamped data being recorded or time-stamped data previously recorded and stored in the node database, which has not yet been synchronized with true time.

The steps of an illustrative, non-limiting, exemplary ‘inverse timing’ method are shown in FIG. 2. Autonomous nodes (e.g. ocean bottom sensors (OBSs) include, among other components, a clock as known in the art. Such clock may be an atomic clock or other timing devices as known in the art. To conserve node battery power, the local node clock (and the node itself) may be powered down and put into a non-running condition for periods of time while the node sits on the ocean floor between seismic surveys. In preparing to conduct a new seismic survey, the local node clock must be powered-up/turned ON and the running condition establishes as at step 201. The running local node clock will be characterized by a timing schedule that provides a time stamp record (data stream) recorded in a node database as at step 203. Although not expressly shown as a step in FIG. 2, it will be advantageous to determine a stabilization characteristic, parameter, or metric for the node clock to assure that the clock is running precisely and accurately after start-up so that an accurate association of the timing schedule with ‘true’ time can be made. At step 205 the seismic record is made by recording seismic data and saving the data in a node database. Thus far, new seismic data has been recorded or a prior seismic data record has been saved, and associated with the time-stamped timing schedule of the local clock; however, the real or ‘true’ time of the data collection is not known due to the unsynchronized state of the local clock after being in its sleep/OFF mode. At step 209 the true time value known from an external true time platform is transferred to the node or, alternatively, at step 211 the node time values are transferred from the node to a true time platform. A discrete point of the data record (e.g., stop-record time) is then associated with the time stamped timing schedule for each set of data records to establish a synchronization time and the true time is associated with the synchronization time at step 213. Each set of synchronized data records can be saved as metadata as at step 215. Using the time stamped timing schedule associated with a synchronized data record, true times can now accurately be assigned to each time stamp after the survey has been recorded.

The synchronization may be assigned a known time offset as appropriate. The illustrative steps (209, 211) of transferring true times/node times to/from an external true time platform and a node for ultimately associating a true time with the synchronization time may be done without any physical contact with the deployed node. An RF, electrical, inductive, or acoustic communication link may be made with the node. In an advantageous aspect, an ROV or AUV, for example, may be brought into proximity with the node and a high bandwidth optical communication link established there between to transfer time values and survey data. Data could also optically be transferred between adjacent nodes for collection by, and transmission from, one or more primary nodes such that, for example, a data transfer between a primary node and an AUV would encompass recorded data from a plurality of non-primary nodes optically coupled to the one or more primary nodes.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

We claim:

1. A timing method, comprising:
establishing a running condition of a local node clock in each of one or more nodes, including generating a local timing schedule;
recording seismic data with the node while the timing schedule is running to generate a seismic record;
selecting a time of the seismic data recording with a discrete value of the timing schedule of the running node clock to establish a synchronization time;
associating a true time with the synchronization time; and
assigning the true time to the discrete value of the timing schedule of the running node clock,
wherein the timing schedule of the running node clock prior to the discrete value of the timing schedule can be accurately associated the true time.

2. The method of claim 1, further comprising establishing the running condition of the node clock(s) after the node(s) is deployed on the sea floor.

3. The method of claim 1, further comprising waking-up/starting the local node clock.

4. The method of claim 1, further comprising determining a stabilization characteristic, parameter, or metric for the node clock.

5. The method of claim 4, wherein the stabilization characteristic, parameter, or metric for the node clock enables an accurate association of the timing schedule of the running node clock during a start-up, warm-up, imprecise, close, or non-stabilized duration or portion of the timing schedule with corresponding true time.

6. The method of claim 1, further comprising making the seismic survey data record with the node simultaneously with the timing schedule of the running node clock.

7. The method of claim 1, wherein the step of associating a true time with the synchronization time involves establishing at least one of an RF, electrical, inductive, and acoustic communication link with the node.

8. The method of claim 1, wherein the step of associating a true time with the synchronization time involves establishing an optical communication link with the node.

9. The method of claim 8, further comprising establishing the optical communication link between the node and at least one of a submerged ROV, an AUV, one or more other nodes, and a towed vehicle.

10. The method of claim 1, further comprising transferring the discrete value of the timing schedule of the running node clock to a node-external location associated with the true time.

11. The method of claim 1, further comprising establishing a true source signal start time, tₜᵣᵤₑ for a given seismic data survey.

12. The method of claim 11, further comprising correlating the true node time with the true source signal start time, tₜᵣᵤₑ for the given seismic data survey.

13. The method of claim 1, further comprising reassigning a true node time to one or more prior recorded seismic data survey records made by a node.

14. The method of claim 1, wherein the node clock is an atomic clock.

15. The method of claim 11, wherein the true source signal start time, tₜᵣᵤₑ is based on a GPS, GPS III, GLONASS (Russian GLObal NAvigation Satellite System), European Union Galileo positioning system, Chinese Compass navigation system, Indian Regional Navigational Satellite System, or other similar system.

16. The method of claim 1, wherein establishing a survey record involves creating a metacontent for a dataset associated with the given seismic survey.

17. The method of claim 16, further comprising establishing a time offset between a true time value and a discrete timing value of the node clock in the metacontent.

18. The method of claim 1, further comprising performing all method steps without physical contact with the node in the operational environment of the node.

19. An inverse timing system, comprising:
a true time source;
a node operatively, wirelessly coupled to the true time source,
wherein the node includes a local clock characterized as being in one of a non-running/sleep mode and a running mode and further characterized by a timing schedule and a time stamp in the running mode,
further wherein the node includes a data recorder and a data record file operatively coupled to the timing schedule, wherein the data record file contains new recorded seismic data or does not contain new recorded seismic data;
at least one of a transmitter, a receiver, and a transceiver operatively coupled to the true time source and the node,
wherein the local node clock is in a running condition for a given time after the data record file contains new recorded seismic data prior to being in a synchronized running condition after the data record file contains new recorded seismic data.
